(19) United States
(12) Patent Application Publication
(10) Pub. No.: US 2019/0302805 A1
(43) Pub. Date: Oct. 3, 2019

(54) SYSTEM AND METHOD FOR OPERATING DRONES UNDER MICRO-WEATHER CONDITIONS

(71) Applicant: Walmart Apollo, LLC, Bentonville, AR (US)

(72) Inventors: Donald R. High, Noel, MO (US); Robert L. Cantrell, Herndon, VA (US); John J. O'Brien, Farmington, AR (US)

(21) Appl. No.: 16/357,485

(22) Filed: Mar. 19, 2019

Related U.S. Application Data
(60) Provisional application No. 62/649,149, filed on Mar. 28, 2018.

(51) Int. Cl. G05D 1/10; H04L 29/08

(52) U.S. Cl. CPC G05D 1/101; H04L 67/12

(57) ABSTRACT

A plurality of electronic nodes sense, in real-time, micro-weather data. Each of the plurality of electronic nodes is communicatively coupled to an electronic aggregation node. The electronic aggregation node is configured to receive the micro-weather data. A control circuit is further configured to determine, based upon an analysis of the micro-weather data, and micro-weather conditions occurring in a limited geographic area, and a recommendation for a suggested maneuver to an aerial drone. The recommendation is effective to advantage the operation of the drone while operating within the geographic area under the micro-weather conditions.

### CROSS-REFERENCE TO RELATED APPLICATION

This application claims the benefit of the following U.S. Provisional Application No. 62/649,149 filed Mar. 28, 2018, which is incorporated herein by reference in its entirety.

### TECHNICAL FIELD

These teachings relate to operating aerial drones and, more specifically, to operating drones to take advantage of actual and/or predicted micro-weather conditions.

### BACKGROUND

Aerial drones are used for various tasks. In one example, aerial drones are used to deliver packages to the homes of customers, warehouses, distribution centers, or retail stores. In other examples, drones can be used to perform non-delivery tasks such as surveillance or monitoring.

One operational condition that affects drone operation is the weather. Weather can occur over a large area such as a state or country. However, weather can also be measured across a smaller, defined geographic area such as along a particular street or within a particular neighborhood of a city. Generally speaking, these later type of weather conditions are referred to as micro-weather conditions.

As a drone operates, the drone can be adversely affected by micro-weather conditions. For example, wind, temperature, and humidity can adversely affect how the drone operates. In some situations, the drone may be critically impacted by these conditions such as when severe wind gust causes the drone to crash.

### BRIEF DESCRIPTION OF THE DRAWINGS

The above needs are at least partially met through the provision of approaches that allow drones to operate under and take advantage of micro-weather conditions, wherein:

FIG. 1 comprises a diagram of a system as configured in accordance with various embodiments of these teachings;

FIG. 2 comprises a flowchart as configured in accordance with various embodiments of these teachings;

FIG. 3 comprises a diagram as configured in accordance with various embodiments of these teachings.

### DETAILED DESCRIPTION

Generally speaking, micro-weather conditions are sensed allowing an aerial drone to be pre-maneuvered to take advantage of these conditions. This is different from obtaining weather data and changing course based upon the data. The present approaches leverage and use the conditions to improve drone performance. Various electronic nodes that collect the micro-weather data are arranged to be able to gather that data. Further, all nodes send their data to an electronic aggregation node, the aggregation node forms a recommendation for drone operation based upon an analysis of the data, and the aggregation node communicates the recommendation to the drone. In this way, the aerial drone is not overwhelmed with too much data coming from a large number of individual nodes.

In examples, a system of ground-based sensors is deployed to areas with high drone traffic and a history of micro-weather events or conditions. These ground-based sensors could, in aspects, be mounted on buildings for better in-situ measurements and recording. Ground-based sensors could also be incorporated in sensitive areas such as hubs, ports and retail stores where drones land frequently. The system predicts micro-weather conditions, routes drones to avoid adverse conditions (actual or predicted), and pre-maneuvers drones to take advantage of predicted and/or actual micro-weather conditions.

In many of these embodiments, a system is configured to pre-maneuver an aerial drone in anticipation of micro-weather conditions occurring in a geographic area. The pre-maneuver is made in order to take advantage of the micro-weather conditions. The system includes an aerial drone, a plurality of electronic nodes, and an electronic aggregation node.

The plurality of electronic nodes is disposed within a localized geographic area. Each of the electronic nodes includes a sensor, and the sensor of each of the electronic nodes is configured to sense, in real-time, micro-weather data. The electronic nodes are arranged in a predetermined pattern.

The electronic aggregation node is communicatively coupled to each of the plurality of electronic nodes and includes a control circuit and a transceiver circuit. The transceiver circuit of the electronic aggregation node is configured to receive the micro-weather data that is selectively transmitted from one or more of the plurality of electronic nodes. The control circuit is further configured to determine, based upon an analysis of the micro-weather data, micro-weather conditions occurring or predicted to occur in the geographic area, and based upon the determined or predicted micro-weather conditions, form a recommendation for a suggested maneuver to the aerial drone. The recommendation is transmitted to the drone via the transceiver circuit and is effective to advantage the operation of the drone while operating within the geographic area according to the micro-weather conditions.

The aerial drone is configured to receive the recommendation, determine whether to accept the recommendation according to a set of rules stored at the aerial drone, and, when the recommendation is accepted, adjust operation of the drone according to the recommendation before reaching the geographic area.

In aspects, the set of rules considers factors such as the route of the drone, the altitude of the drone, the speed of the drone, or the location of the drone. The aerial drone compares one or more of these factors to the recommendation in order to determine whether to accept the recommendation.

In other examples, the pattern of arrangement of the nodes (e.g., the number and positioning) is conducive to detecting the existence of the micro-weather conditions. For example, the sensors may be arranged in a pattern along a street such that the wind pattern along the street can definitively be detected.

In other aspects, each of the plurality of electronic nodes transmits weather data to the aggregation node when a predetermined threshold is exceeded. In examples, the threshold relates to a change in temperature, a change in pressure, a change in wind speed, changing weather conditions, or a change with respect to historical data. Other examples are possible.

In yet other examples, the recommendation is to adjust the speed of the drone, adjust the tilt of the drone, or adjust the altitude of the drone. Other recommendations are possible.

The micro-weather conditions can relate to a wide variety of weather types or aspects. For example, the micro-weather conditions can relate to wind or precipitation occurring within the geographic area.

The geographic area can be a wide variety of areas. For example, the geographic area can be an area of a city, a neighborhood, an area along a street, or can be in the immediate vicinity of a destination (e.g., the porch of a home), or any other area. Other examples are possible.

In others of these embodiments, approaches are provided for pre-maneuvering an aerial drone in anticipation of micro-weather conditions occurring in a geographic area in order to take advantage of the micro-weather conditions. A plurality of electronic nodes is disposed within a localized geographic area. Each of the electronic nodes includes a sensor and the sensor of each of the electronic nodes is configured to sense, in real-time, micro-weather data, the electronic nodes being arranged in a predetermined pattern.

Each of the plurality of electronic nodes is communicatively coupled to an electronic aggregation node. The electronic aggregation node includes a control circuit and a transceiver circuit. The transceiver circuit of the electronic aggregation node is configured to receive the micro-weather data that is selectively transmitted from one or more of the plurality of electronic nodes. The control circuit is further configured to determine, based upon an analysis of the micro-weather data, micro-weather conditions occurring or predicted to occur in the limited geographic area, and based upon the determined micro-weather conditions, form a recommendation for a suggested maneuver to an aerial drone. The recommendation is transmitted to the aerial drone via the transceiver circuit. The recommendation is effective to advantage the operation of the drone while operating within the geographic area under the micro-weather conditions or predicted conditions.

The recommendation is received at the aerial drone. The aerial drone determines whether to accept the recommendation according to a set of rules stored at the aerial drone. When the recommendation is accepted, operation of the drone is adjusted according to the recommendation before reaching the geographic area.

In other aspects, a four-cup anemometer could be used at the nodes for measuring wind speed and direction. If the measurements indicate that the conditions are right for the formation of adverse micro-weather conditions, the system could predict that these micro-weather conditions are likely, and the system could proceed to take evasive action. The system could dynamically adjust operation of the drone when wind conditions indicate problems at, for example, a certain street intersection. The system could route deliveries to an alternate location (e.g., an alternative kiosk) during particularly severe micro-weather events.

In other examples, the electronic nodes initially monitor and log the micro-weather data (in a memory storage device at the node) until a correlation between weather conditions and micro-weather events are established. Machine learning could be employed to facilitate the correlations. After the weather and micro-weather are correlated, the system could reduce the monitoring frequency and simply log and record data when the measurement exceeds a level plus or minus a delta value. To take one example, winds that consistently lie below 4 knots, may warrant a data point record only hourly. Weather that is consistent with its normal patterns will not be recorded and analyzed. In this way, the system is inherently efficient.

The electronic nodes could also function in a power-saving mode. When in this mode, the electronic nodes will only function to record and analyze weather changes when needed by a device, such as an aerial drone. In this way, the system operation is more efficient as it conserves power when the power is not needed.

The approaches may be utilized at various phases of drone operation such as takeoffs, landings, and in-flight. For example, the approaches described herein can be deployed at package delivery locations (e.g., at kiosks) that are geographically in optimal locations for safety, but because of the terrain, may be subject to micro-weather problems, such as early morning fog. In some cases, deliveries might not be suitable at a given time even though the general conditions of the weather in a wider geographic area (in which the geographical location for micro-weather event determination is located) are acceptable.

A micro-weather kit may be deployed in areas where unmanned vehicles operate. In examples, the kit may be an electronic node. The kit may sense various micro-weather events such as one or more of an anemometer, a rain gage, a thermometer, an altimeter, a GPS system, a clock, a barometer, a camera that obtains visible images, a lighting detector, a lightning detector, a fog/smoke detector, other types of camera systems, batteries, a data logger (first-in-first-out (FIFO) memory device), a data transmitter/receiver, solar panels (to provide power to the batteries), and a wind generator. This kit would function as an Internet of Things (IoT) device and transmit/receive data to and from the cloud and vehicles in the vicinity. Nearby micro-weather stations (nodes) could communicate and may be used to upload the measured data to the cloud. The system may use cameras to detect congestion by people and traffic. Another use of the cameras is to detect animals, such as birds, operating in the area.

In other examples, microphones could be added to the system to record the noise-level of the area. The system will also have components to detect interference related to electromagnetic, magnetic, radio frequency, infrared, and so forth. Photocells could be used to detect the lighting conditions in the area. Lastly, the micro-weather stations could act as stations to recharge vehicles.

In other aspects, sensors external to the drone but specific to an area are used to capture real-time data for micro-weather events. Micro-weather devices may communicate together in a network, sharing and distributing their specific data, which can then be aggregated and shared with the drone or a central authority. Since the devices are doing the majority of the data gathering work, this reduces some of the work required for the drone to aggregate and assemble this information. Thus, a localized subset of devices can work together to define the micro-weather of that area. Only one communication with a drone or central authority is needed.

If weather capturing devices actively sensed and distributed information relating to the micro-weather events all the time, then the drone or aggregation node would be bombarded or overwhelmed with data. In aspects, a trigger is used to execute when a micro-event needs to be captured (stored in memory) and shared. Thresholds will define when a passive capturing of information by a weather capturing device needs to be distributed. Thus, if a less than required change occurs in the temperature, then the weather capturing device will not store and/or share this information (e.g., with an aggregation node or an aerial drone). Further, if the change resembles historical data, then there is no need to distribute the data. The present approaches the efficient management of the large amount of data being collected and that are only distributed when absolutely necessary. Further, instead of it being completely reliant upon delta, which could also be inefficient, it compares the data against known/historical trends. If a satisfactory change occurs between the real-time data and the known historical data, then the real-time data is distributed.

Although drone routes are potentially adjusted utilizing the approaches described herein, these approaches allow pre-maneuvering of the vehicles to take advantage (and not simply avoid) potentially adverse micro-weather conditions. In one example, by knowing what the wind gust will be around a building, a drone can be predictively maneuvered in such a way as to take advantage of the wind gust. For instance, the pre-tilt of the drone can be adjusted in a way that can not only counter the gust, but potentially ride the gust, and improve drone performance.

Advantageously, safety is improved using the present approaches. Additionally, the approaches described herein allow the extraction of information about an area to ensure the drone is operating correctly. Furthermore, efficiency of drone operations (and overall delivery operations) is improved as micro-weather data is utilized to advantage drone operation.

It will be appreciated that although the present approaches describe optimizing the operation of aerial vehicles (such as drones), these approaches may also be utilized in the same or similar ways to modify the operation of ground vehicles (e.g., automated ground vehicles).

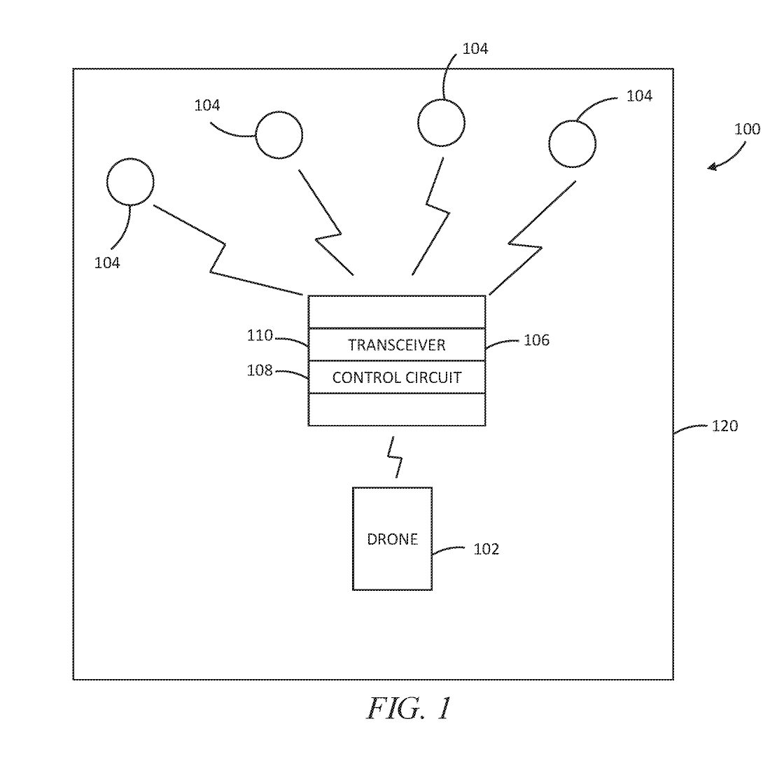

Referring now to FIG. 1, a system 100 configured to pre-maneuver an aerial drone 102 in anticipation of (or in reaction to) micro-weather conditions occurring in a geographic area 120 is described. The pre-maneuver is made in order to take advantage of the micro-weather conditions.

The micro-weather conditions can relate to a wide variety of weather types or aspects. For example, the micro-weather conditions can relate to wind or precipitation occurring within the geographic area 120.

The geographic area 120 can be a wide variety of areas. For example, the geographic area 120 can be an area of a city, a neighborhood, an area along a street, or can be in the immediate vicinity of a destination (e.g., the porch of a home), or any other area. Other examples are possible.

The system 100 includes the aerial drone 102, a plurality of electronic nodes 104, and an electronic aggregation node 106.

The aerial drone 102 is any type of aerial vehicle that includes a transceiver circuit (for receiving recommendation messages), a control circuit (configured to determine whether to accept or reject the recommendation), a propulsion system (such as propellers, an engine, and a power system, and which is controlled by the control circuit of the drone 102), a cargo bay (for storing packages or other items to be delivered by the drone 102). In aspects, the drone 102 is autonomous (e.g., it independently operates itself and is not under the direct control of some other entity such as a central control center). It will be appreciated that automated ground vehicles can also operate according to the approaches described herein. In other words, the aerial drone 102 can be exchanged for an automated ground vehicle.

In aspects, the plurality of electronic nodes 104 include sensors or sensing devices, a transceiver circuit (or transmission device) that transmit sensed data, an electronic memory, and a control circuit or controller that determines when to make transmissions to the aggregation node 106.

The sensor of each of the electronic nodes 104 is configured to sense, in real-time, micro-weather data, and the electronic nodes 104 are arranged in a predetermined pattern. The sensors may include an anemometer, a rain gage, a thermometer, an altimeter, a GPS system or device, a clock, a barometer, a camera, a lightning detector, a lighting detector, a fog/smoke detector, and/or batteries. Other examples of sensors are possible.

The electronic memory at each of the electronic nodes 104 stores data as collected. In other examples, the data may only be stored at predetermined time intervals or when the data changes substantially (e.g., exceeds a threshold) compared to historical data. Thus, the amount of data being stored before distribution to the aggregation node 106 may be minimized. Additionally, the present approaches offer the efficient management of large amounts of data since distributions to the aggregation node 106 are also controlled.

The electronic aggregation node 106 is communicatively coupled to each of the plurality of electronic nodes 104 and includes a control circuit 108 and a transceiver circuit 110. The transceiver circuit 110 of the electronic aggregation node 106 is configured to receive the micro-weather data that is selectively transmitted from one or more of the plurality of electronic nodes 104. In aspects, the electronic aggregation node 106 may be one of the plurality of electronic nodes 104, i.e., the electronic aggregation node 106 may also include sensing devices that obtain micro-weather data.

It will be appreciated that as used herein the term “control circuit” refers broadly to any microcontroller, computer, or processor-based device with processor, memory, and programmable input/output peripherals, which is generally designed to govern the operation of other components and devices. It is further understood to include common accompanying accessory devices, including memory, transceivers for communication with other components and devices, etc. These architectural options are well known and understood in the art and require no further description here. The control circuit 108 may be configured (for example, by using corresponding programming stored in a memory as will be well understood by those skilled in the art) to carry out one or more of the steps, actions, and/or functions described herein.

The control circuit 108 is configured to determine, based upon an analysis of the micro-weather data, micro-weather conditions occurring in the geographic area 120, and based upon the determined micro-weather conditions, form a recommendation for a suggested maneuver to the aerial drone 102. The recommendation is transmitted to the drone 102 via the transceiver circuit 110 and is effective to advantage the operation of the drone while operating within the geographic area 120 according to the micro-weather conditions.

The aerial drone 102 is configured to receive the recommendation, determine whether to accept the recommendation according to a set of rules stored at the aerial drone 102, and, when the recommendation is accepted, adjust operation of the drone 102 according to the recommendation before reaching the geographic area 120.

In aspects, the rules are combination of computer code and/or data structures that are effective to analyze a recommendation. The rules may require various inputs (e.g., the present altitude or speed of the drone 102), a test implemented as computer code (e.g., compare the present altitude of the drone to the proposed adjustment), and then a response or result (e.g., when the proposed adjustment to altitude in a downward direction is greater than the present altitude, do not follow the recommendation).

In other aspects, the set of rules considers factors including the route of the drone 102, the altitude of the drone, the speed of the drone, or the location of the drone, and the aerial drone compares one or more of these factors to the recommendation. Other examples are possible. For example, when the altitude of the drone is 50 feet, and the recommendation is to lower the altitude by 100 feet, the recommendation is not accepted because the result of following the recommendation would be to crash the drone 102 into the ground.

In aspects, the pattern is conducive to detecting the existence of the micro-weather conditions. For example, the nodes 104 may be arranged in a pattern along a street such that the wind pattern can definitively be detected. The pattern may be determined, for example, by obtaining test data of proposed areas, adjusting locations of the nodes 104 when it is found the information is not useful in detecting micro-weather patterns, and placing nodes 104 in positions where micro-weather conditions can be determined or measured. To take a specific instance, a first proposed position of a node may be at a location where the wind is blocked by another structure. By confirming that no wind can be measured from this position, an alternative position can be detected. Both the position and the number of nodes is selected so as to be able to adequately detect wind patterns and gusts.

In other aspects, each of the plurality of electronic nodes 104 transmit weather data to the aggregation node 106 when a predetermined threshold is exceeded. In examples, the threshold relates to a change in temperature, a change in pressure, a change in wind speed, changing weather conditions, or a change with respect to historical data. Other examples are possible. For example, transmissions may occur when a change of predetermined value occurs with these conditions (e.g., the temperature changes by 2 degrees). In other examples, transmissions are made at predetermined time intervals (e.g., once a day or once an hour). In still other examples, transmissions are made when a threshold of one or more of the values is reached (e.g., the temperature falls below 0 degrees F., or exceeds 60 degrees F.).

In other examples, data is only stored at the nodes 104 when certain conditions are met, such as the conditions described above. In other examples, all sensed data is stored.

In yet other examples, the recommendation is to adjust the speed of the drone 102, adjust the tilt of the drone 102, or adjust the altitude of the drone 102. Other recommendations are possible.

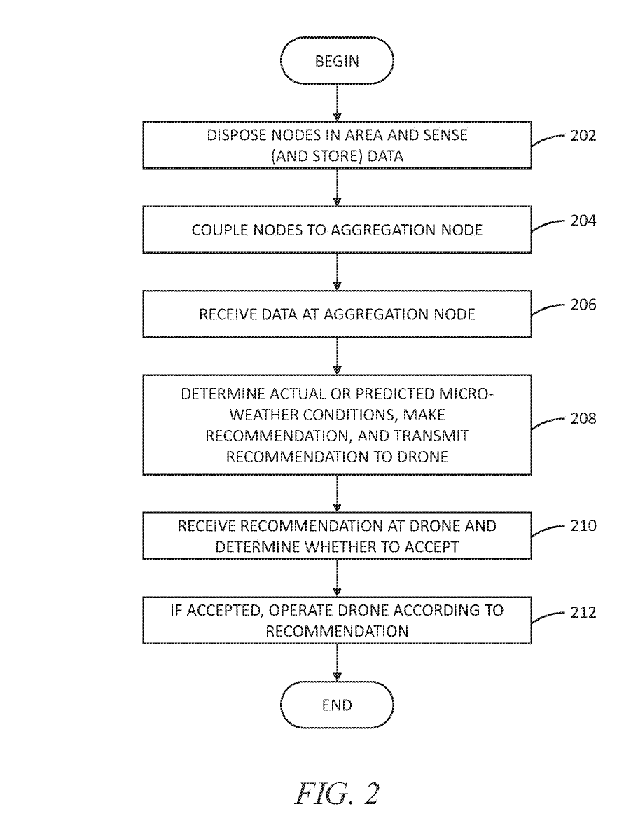

Referring now to FIG. 2, an approach to pre-maneuver an aerial drone in anticipation of micro-weather conditions occurring in a geographic area is described. At step 202, a plurality of electronic nodes is disposed within a localized geographic area. Each of the electronic nodes includes a sensor and the sensor of each of the electronic nodes is configured to sense, in real-time, micro-weather data. The electronic nodes are arranged in a predetermined pattern. In some examples, only some of the data is stored, for example, at predetermined thresholds or when certain conditions (e.g., the change of a parameter by a threshold) are met. In other examples, all data is recorded and stored in memory at the nodes.

At step 204, each of the plurality of electronic nodes is communicatively coupled to an electronic aggregation node. The electronic aggregation node includes a control circuit and a transceiver circuit.

At step 206, the transceiver circuit of the electronic aggregation node is configured to receive the micro-weather data that is selectively transmitted from one or more of the plurality of electronic nodes. The transmissions may occur when predetermined conditions occur (e.g., the change of a parameter by a threshold), or at predetermined intervals to mention two examples. In other examples, the nodes transmit to the aggregation node at staggered times (i.e., not at the same time).

At step 208, the control circuit is further configured to determine, based upon an analysis of the micro-weather data, micro-weather conditions occurring in the limited geographic area. Based upon the determined micro-weather conditions, a recommendation is formed for a suggested maneuver to an aerial drone. The recommendation is transmitted to the aerial drone via the transceiver circuit. The recommendation is effective to advantage the operation of the drone while operating within the geographic area under the micro-weather conditions.

At step 210, the recommendation is received at the aerial drone. The aerial drone determines whether to accept the recommendation according to a set of rules stored at the aerial drone.

At step 212, when the recommendation is accepted, the operation of the drone is adjusted according to the recommendation before reaching the geographic area.

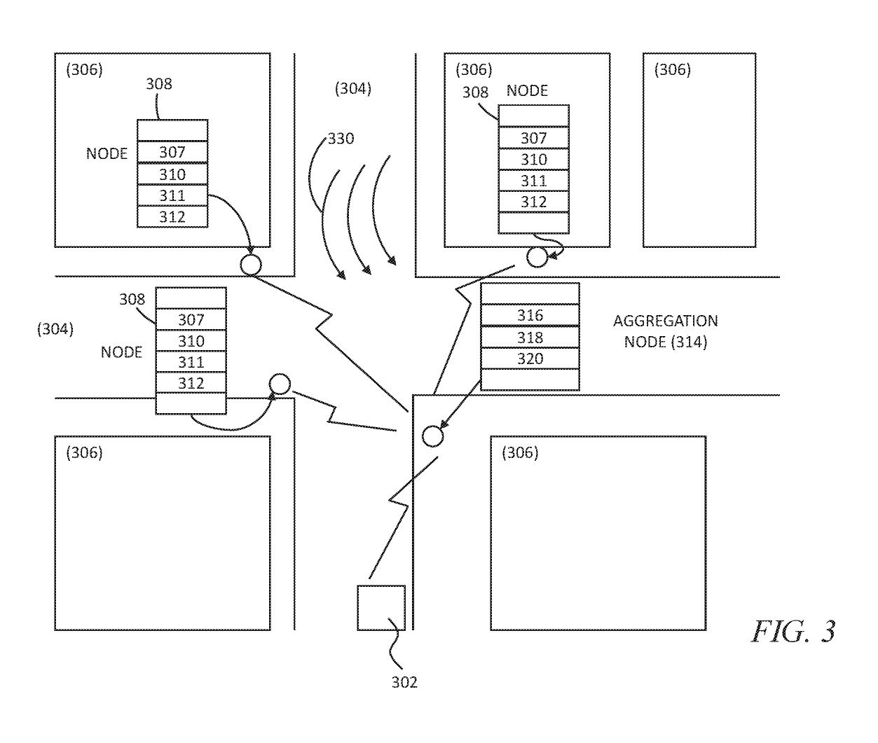

Referring now to FIG. 3, one example of changing the operation of a drone 302 is described. The drone 302 operates in a downtown area of a city having streets 304 and buildings 306. Electronic nodes 308 collect micro-weather data from sensors 307. In this example, the nodes 308 include wind speed sensors (and potentially other types of sensors that sense other conditions indicative of wind speed such as atmospheric pressure and temperature). Each of the nodes 308 also includes a transceiver circuit 310, an electronic memory 311, and a control circuit 312. The control circuit 312 of each of the nodes 308 is configured to transmit data collected by its respective transceiver circuit 310 upon a change of windspeed that meets a pre-determined threshold. The transceiver circuit 310 sends the data to an aggregation node 314. The aggregation node 314 includes a control circuit 316, a database 318, and a transceiver circuit 320.

In one example, all data sensed is stored in the memory 311. In other examples, only some of the sensed data is stored in the memory 311. For example, data may only be stored as it changes by a threshold (e.g., a temperature is stored and recorded for an amount of time, but then the temperature is not stored unless it changes by a threshold amount).

The transceiver circuit 320 of the aggregation node 314 is configured to receive the micro-weather data that is selectively transmitted from the nodes 308. The control circuit 316 is further configured to determine, based upon an analysis of the windspeed data, whether there are wind gusts 330 that can advantageously be used by the drone 302 to increase the speed of the drone 302. In other aspects, the control circuit 316 may determine a prediction as to whether and/or when wind gusts 330 will occur.

The control circuit 316 forms a recommendation to advantage the operation of the drone 302, for example, to adjust the tilt of the drone 302 as it enters the area where the wind gusts 330 are occurring or predicted to occur. The recommendation is sent to the drone 302 via the transceiver circuit 320 and is effective to (assuming the drone 302 agrees with the recommendation) cause the drone 302 to change its operation (e.g., adjust its tilt) and advantage the operation of the drone 302 (e.g., increase its speed) while operating within the geographic area according to the actual or predicted wind gusts 330. The recommendation may be stored in the database 318.

Those skilled in the art will recognize that a wide variety of modifications, alterations, and combinations can be made with respect to the above described embodiments without departing from the scope of the invention, and that such modifications, alterations, and combinations are to be viewed as being within the ambit of the inventive concept.

What is claimed is:

1. A system that is configured to pre-maneuver an aerial drone in anticipation of micro-weather conditions occurring in a geographic area, the pre-maneuver being made in order to take advantage of the micro-weather conditions, the system comprising:
an aerial drone;
a plurality of electronic nodes disposed within a localized geographic area, each of the electronic nodes including a sensor, wherein the sensor of each of the electronic nodes is configured to sense, in real-time, micro-weather data, the electronic nodes being arranged in a predetermined pattern;
an electronic aggregation node communicatively coupled to each of the plurality of electronic nodes, the electronic aggregation node including a control circuit and a transceiver circuit, the transceiver circuit of the electronic aggregation node being configured to receive the micro-weather data that is selectively transmitted from one or more of the plurality of electronic nodes, the control circuit further configured to determine, based upon an analysis of the micro-weather data, micro-weather conditions occurring or predicted to occur in the geographic area, and based upon the determined or predicted micro-weather conditions, form a recommendation for a suggested maneuver to the aerial drone, the recommendation being sent to the drone via the transceiver circuit, the recommendation being effective to advantage the operation of the drone while operating within the geographic area according to the micro-weather conditions;
wherein the aerial drone is configured to receive the recommendation, determine whether to accept the recommendation according to a set of rules stored at the aerial drone, and, when the recommendation is accepted, adjust operation of the drone according to the recommendation before reaching the geographic area.

2. The system of claim 1, wherein the set of rules considers factors including the route of the drone, the altitude of the drone, the speed of the drone, or the location of the drone, and the aerial drone compares one or more of these factors to the recommendation.

3. The system of claim 1, wherein the pattern is conducive to detecting the existence of the micro-weather conditions.

4. The system of claim 1, wherein each of the plurality of electronic nodes transmit weather data to the aggregation node when a predetermined threshold is exceeded.

5. The system of claim 4, wherein the threshold relates to a change in temperature, a change in pressure, a change in wind speed, changing weather conditions, or a change with respect to historical data.

6. The system of claim 1, wherein the recommendation is to adjust the speed of the drone, adjust the tilt of the drone, or adjust the altitude of the drone.

7. The system of claim 1, wherein the micro-weather condition relates to wind or precipitation occurring within the geographic area.

8. The system of claim 1, wherein the geographic area is an area of a city, or in the immediate vicinity of a destination.

9. A method for pre-maneuvering an aerial drone in anticipation of micro-weather conditions occurring in a geographic area in order to take advantage of the micro-weather conditions, the method comprising:
disposing a plurality of electronic nodes within a localized geographic area, each of the electronic nodes including a sensor, wherein the sensor of each of the electronic nodes is configured to sense, in real-time, micro-weather data, the electronic nodes being arranged in a predetermined pattern;
communicatively coupling each of the plurality of electronic nodes to an electronic aggregation node, the electronic aggregation node including a control circuit and a transceiver circuit, the transceiver circuit of the electronic aggregation node being configured to receive the micro-weather data that is selectively transmitted from one or more of the plurality of electronic nodes, the control circuit further configured to determine, based upon an analysis of the micro-weather data, micro-weather conditions occurring or predicted to occur in the geographic area, and based upon the determined or predicted micro-weather conditions, form a recommendation for a suggested maneuver to an aerial drone, the recommendation being transmitted to the aerial drone via the transceiver circuit, the recommendation being effective to advantage the operation of the drone while operating within the geographic area under the micro-weather conditions;
receiving the recommendation at the aerial drone, determining by the aerial drone whether to accept the recommendation according to a set of rules stored at the aerial drone, and, when the recommendation is accepted, adjust operation of the drone according to the recommendation before reaching the geographic area.

10. The method of claim 9, wherein the set of rules considers factors including the route of the drone, the altitude of the drone, the speed of the drone, or the location of the drone, and the aerial drone compares one or more of these factors to the recommendation.

11. The method of claim 9, wherein the pattern is conducive to detecting the existence of the micro-weather conditions.

12. The method of claim 9, wherein each of the plurality of electronic nodes transmit weather data to the aggregation node when a predetermined threshold is exceeded.

13. The method of claim 12, wherein the threshold relates to a change in temperature, a change in pressure, a change in wind speed, changing weather conditions, or a change with respect to historical data.

14. The method of claim 9, wherein the recommendation is to adjust the speed of the drone, adjust the tilt of the drone, or adjust the altitude of the drone.

15. The method of claim 9, wherein the micro-weather condition relates to wind or precipitation occurring within the geographic area.

16. The method of claim 9, wherein the geographic area is an area of a city, or in the immediate vicinity of a destination.
